(19) United States
(12) Patent Application Publication
(10) Pub. No.: US 2004/0181953 A1
(43) Pub. Date: Sep. 23, 2004

(54) Shaving implement

(75) Inventors: Thomas A. Follo, Milford, CT (US); Paul R. Dansreau, Shelton, CT (US); Max Arthur Lembke, Greenford (GB); John F. Pacilio, West Haven, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/785,834

(22) Filed: Feb. 24, 2004

Related U.S. Application Data
(60) Provisional application No. 60/449,931, filed on Feb. 25, 2003.

(51) Int. Cl. B26B 19/42

(52) U.S. Cl. 30/527

(57) ABSTRACT

In a shaving implement a handle includes a shaving head that defines an interior area. An actuator is coupled to the shaving head for movement between a neutral position, and a cartridge ejecting position. The cartridge retainer includes a portion projecting outwardly from the shaving head defining at least one cartridge engaging surface adapted to slidably engage a complimentarily shaped slot that extends longitudinally of a rear surface defined by a razor cartridge mounted to the shaving implement. The razor cartridge is releasably coupled to the cartridge retainer so that it is movable between a non-rotated and a rotated position with the cartridge being urged toward the non-rotated position in response to an externally applied force.

### CROSS-REFERENCE TO RELATED APPLICATIONS

This application is entitled to the benefit of and incorporates by reference essential subject matter disclosed in Provisional Patent Application No. 60/449,931 filed on Feb. 25, 2003.

### FIELD OF THE INVENTION

The present invention is generally directed to implements for shaving hirsute surfaces, and is more particularly directed to a shaving implement that provides ease of engagement between a razor handle and a blade carrying cartridge.

### BACKGROUND OF THE INVENTION

Modern razors are generally supplied in two manners, those where the entire razor is disposable, and those where only the blade carrying cartridge is disposable, the handle being retained for reuse. Regarding the latter, the disposable cartridge is usually mounted to the razor handle via a pair of extremely small retractable arms having even smaller ends that engage equally small recesses located on a rear surface of the disposable cartridge.

Typically, disposable cartridges are snap-fit into a tray and are provided to consumers in this configuration. To remove a disposable cartridge from the tray, a user must align the ends of the arms while maintaining the arms, in a retracted position, with the recesses in the disposable cartridge and then release an actuator to allow the ends of the arms to move into engagement with the recesses. The user must then, using the handle, pull the disposable cartridge out of the tray. A difficulty associated with shaving implements configured in this manner is that it can prove incommodious to align the pins and the recesses. In addition, once the pins are engaged in the recesses they often disengage before the cartridge is pulled from the tray causing the user to repeat the alignment process. Accordingly, there is a need for a razor handle and disposable cartridge that are easily aligned with one another during engagement of the handle with the cartridge.

Another difficulty sometimes encountered when using shaving implements of the above-described type occurs as a result of the razor handle, with or without a razor cartridge mounted thereon, being dropped. Because razors are usually used in conjunction with water, soap, or other shaving aids, the handles can become slippery making these razors prone to being dropped. Since razors are generally used in bathrooms often having hard tile or marble floors the resulting impact can damage the handle, or the disposable cartridge or can cause the handle and cartridge to separate. If the handle and cartridge separate, the user must then reassemble them with the cartridge now outside of the above-described tray.

Yet another difficulty associated with the above-described razors occurs as a result of the cartridge being angularly movable, essentially up and down relative to the razor handle. To accomplish this, several miniature components must be incorporated directly into the razor handle. This problem is further exacerbated where the cartridge is also angularly movable side-to-side requiring still more miniature components.

Based on the foregoing, it is the general object of the present invention to provide shaving implements that overcome the problems and drawbacks of the prior art.

### SUMMARY OF THE INVENTION

The present invention resides, in one aspect, in a shaving implement that includes a handle having a shaving head that defines an interior area. An actuator is coupled to the shaving head for movement between a neutral position, and a cartridge ejecting position. A cartridge retainer is coupled to and has a portion projecting outwardly from the shaving head. The outwardly projecting portion defines at least one cartridge engaging surface adapted to slidably engage a complimentarily shaped slot extending longitudinally of a rear surface defined by a razor cartridge. Retaining means are provided for releasably coupling the cartridge retainer to the razor cartridge so that the razor cartridge is movable between a non-rotated and a rotated position in response to an externally applied force. Biasing means are also provided for normally urging the razor cartridge toward the non-rotated position.

In an embodiment of the present invention, the retaining means is defined, at least in part, by a portion of the cartridge-engaging surface. This portion releasably and snappingly engages the slot defined by the razor cartridge. In addition, the biasing means includes a plunger, at least a portion of which extends outwardly from the shaving head and engages the razor cartridge. The plunger is movable between an extended and a retracted position and is normally urged toward the extended position which corresponds to the non-rotated position of the razor cartridge. In this embodiment, a spring is interposed between the plunger and the actuator for urging the plunger toward the extended position and the actuator toward the neutral position.

Preferably, a pusher is slidably coupled to the actuator and located, at least in part, in said interior area for movement between a retracted position corresponding to the neutral position of the actuator and an extended position corresponding to the cartridge ejecting position of the actuator. Preferably, a second spring is interposed between and engages the pusher and the actuator, normally biasing the pusher toward the retracted position. In operation as the pusher is moved from the retracted to the extended position, it engages a razor cartridge mounted on the shaving implement and exerts force there against. This force ultimately causes the razor cartridge to disengage from the cartridge retainer.

In this embodiment of the present invention, the cartridge retainer can be partially supported in the interior area of the shaving head for angular movement side-to-side in generally opposite direction from a neutral or central position in response to an externally applied force. The cartridge retainer being normally biased toward the central position.

In all embodiments described herein, the handle of the shaving implement can include damping means to absorb at least a portion of any impact forces exerted against the shaving implement. Preferably, the handle includes an elongated hand-gripping portion that defines an interior cavity. At least one weight is slidably positioned within the interior cavity with at least one resilient member positioned between the weight and the handle to allow the weight to oscillate in response to impact forces exerted against the shaving implement thereby absorbing at least a portion of the energy transmitted by the impact. Preferably, the resilient member includes a pair of generally opposed springs positioned in the cavity, each of the springs being interposed between and engaging the weight and the handle.

In another embodiment of the present invention, the shaving head includes a housing coupled to the handle. At least one shaped pin projects outwardly from a cartridge engaging surface defined by the housing, the pin being adapted to be received in a complimentarily shaped recess defined by the razor cartridge. The pin is coupled to the actuator so that movement thereof from the neutral to the cartridge ejecting position causes the pin to move from an extended to a retracted position. In this embodiment and similar to those already described, a plunger extends outwardly from the housing and engages the razor cartridge normally urging the razor cartridge to the non-rotated position.

The housing coupled to the handle can be either stationery or can move angularly side-to-side relative to the remainder of the handle. In the case where the housing is movable, biasing means, such as, but not limited to a torsion spring are provided between the housing and the remainder of the shaving implement to urge the housing back to a neutral position. In addition, the plunger, actuator, and disposable cartridge all move together with the housing.

### BRIEF DESCRIPTION OF THE DRAWINGS

FIG. 1 is a partial perspective view of an embodiment of a shaving implement of the present invention including a razor cartridge mounted thereon.

FIG. 2 is a partial perspective view of the shaving implement of FIG. 1.

FIG. 3 is a partial side elevational view of the shaving implement of FIG. 1.

FIG. 4 is a partial perspective view of the shaving implement of FIG. 1 showing the razor cartridge removed.

FIG. 5 is a partial perspective view of the shaving implement of FIG. 4 taken from another angle.

FIG. 6 is a perspective view of a mechanism for retaining, ejecting and engaging a razor cartridge, the mechanism being used in the shaving implement of FIG. 1.

FIG. 7 is a perspective view of the mechanism shown in FIG. 6 for retaining, ejecting and engaging a razor cartridge.

FIG. 8 is a side elevational view of the mechanism shown in FIG. 6.

FIG. 9 is a partial perspective view of the shaving implement of FIG. 1 showing an upper part of the handle and shaving head removed and the mechanism of FIG. 6 positioned in an interior area defined by the shaving head.

FIG. 10 is a partial side elevational view of the shaving implement of FIG. 9.

FIG. 11 is a partial perspective view of the shaving implement of FIG. 9 showing a razor cartridge mounted thereon.

FIG. 12 is a partial perspective view of the shaving implement of FIG. 1 showing a lower part of the handle removed and the mechanism of FIG. 6 positioned in an interior area defined by the shaving head.

FIG. 13 is a partial perspective view of the shaving implement of FIG. 12 taken from a different angle.

FIG. 14 is a partial perspective view of the shaving implement of FIG. 1 showing a cartridge retainer having a pair of approximately coaxial spaced apart cartridge engaging surfaces.

FIG. 15 is a partial perspective view of the shaving implement of FIG. 14.

FIG. 16 is a partial cross-sectional perspective view of a shaving implement showing an impact damping spring-mass system located in an interior area defined by the handle.

FIG. 17 is a partial, cross-sectional plan view of an embodiment of a shaving implement of the present invention.

FIG. 18 is a partial, cross-sectional side elevational view of the shaving implement of FIG. 17 showing a razor cartridge mounted thereon in a first rotated position.

FIG. 19 is a partial, cross-sectional side elevational view of the shaving implement of FIG. 17 showing a razor cartridge mounted thereon in a neutral or non-rotated position.

FIG. 20 is a partial, cross-sectional side elevational view of the shaving implement of FIG. 17 showing a razor cartridge mounted thereon in a rotated or ejecting position.

FIG. 21 is a partial, cross-sectional plan view of an embodiment of a shaving implement of the present invention.

FIG. 22 is a partial, cross-sectional side elevational view of the shaving implement of FIG. 21.

FIG. 23 is a partial, cross-sectional plan view of an embodiment of a shaving implement of the present invention.

FIG. 24 is a partial, cross-sectional side elevational view of the shaving implement of FIG. 23.

FIG. 25 is an exploded view of another embodiment of the shaving implement of the present invention.

FIG. 26 is a plan view of the shaving implement of FIG. 25.

FIG. 27 is an exploded parts view of an alternate embodiment of a shaving implement of the present invention.

FIG. 28 is an exploded parts view of a housing forming part of the shaving head of the embodiment of FIG. 27.

FIG. 29 is a perspective view of the main housing of FIG. 28.

FIG. 30 is a perspective view of an impact housing showing a spring and damper mechanism for dissipating energy generated from impact.

FIG. 31 is a perspective view of the main housing of FIG. 29 and the impact housing of FIG. 30 in registration with one another.

FIG. 32 is a perspective view of the main housing in FIG. 29, illustrating the interaction between the main housing and the spring damper mechanism of FIG. 30.

FIG. 33 is another perspective view of the impact housing of FIG. 30.

FIG. 34 is another perspective view of the main housing of FIG. 29 and the impact housing of FIG. 30 in registration with one another.

FIG. 35 is another embodiment of the main housing of FIG. 29.

FIG. 36 is a partial exploded top view of another embodiment of a shaving implement of the present invention showing a mechanism for limiting lateral misalignment.

FIG. 37 is a partial top plan view of the embodiment of FIG. 36 showing a razor cartridge mounted to the shaving implement.

### DETAILED DESCRIPTION OF THE PREFERRED EMBODIMENTS

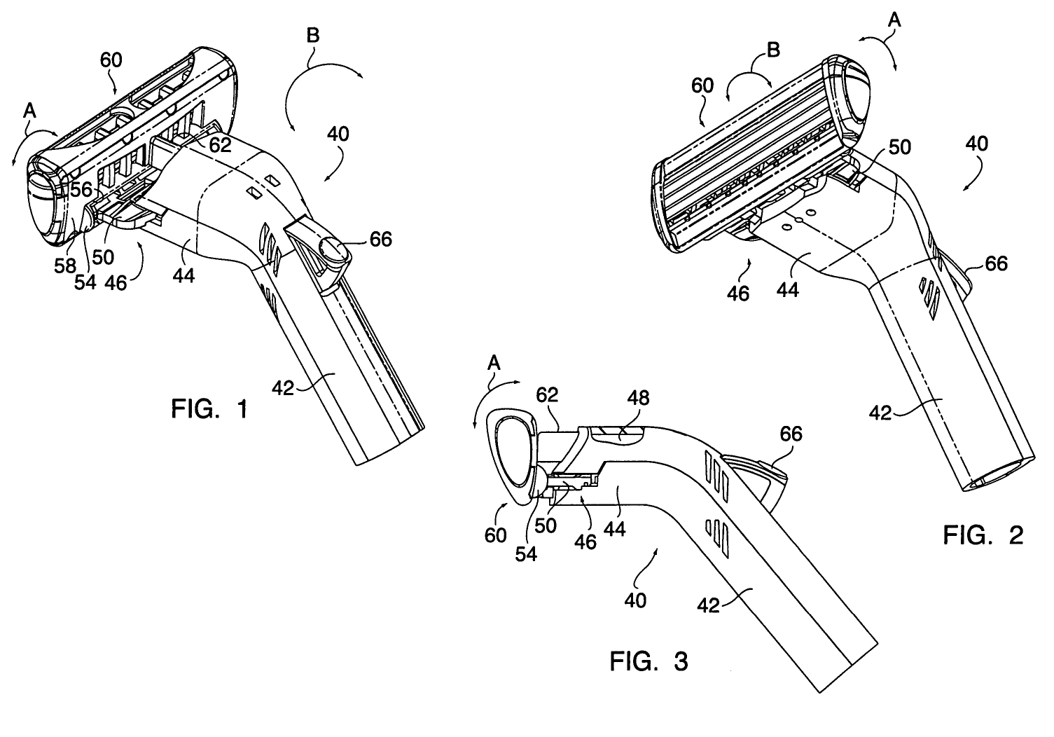

As shown in FIGS. 1-3 a shaving implement embodying the present invention and generally indicated by the reference number 40 includes a handle 42 having a shaving head 44 extending therefrom. A cartridge retainer 46 is supported by the shaving head 44 and in the illustrated embodiment includes a portion located, as will be explained in greater detail herein below, within an interior area 48 defined by the shaving head 44. The cartridge retainer 46 also includes a portion 50 that projects outwardly from the interior area 48.

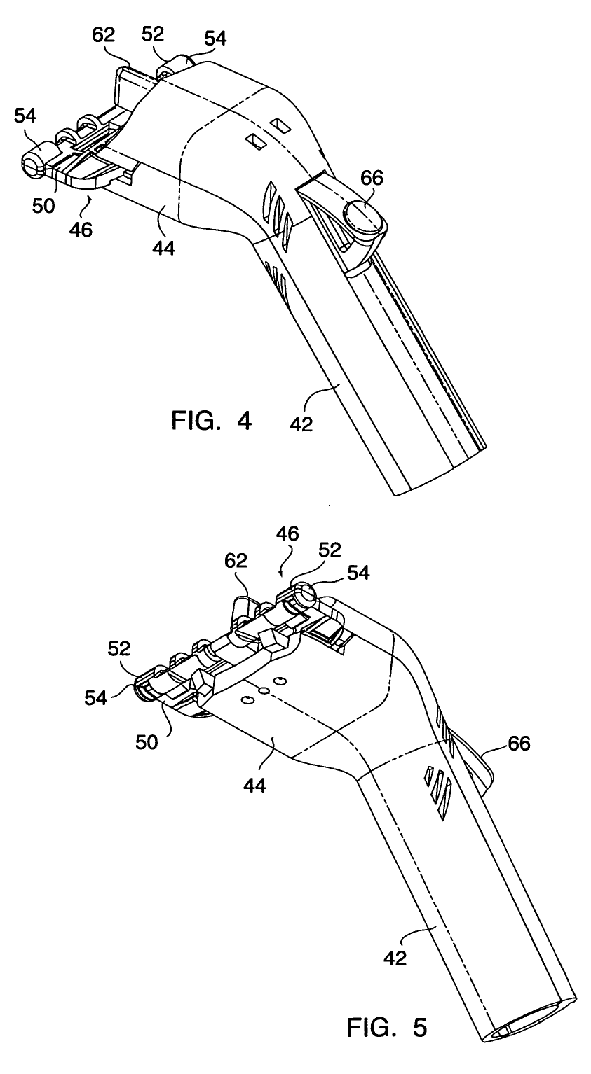

As shown in FIGS. 4 and 5, the outwardly projecting portion 50 includes a cartridge-engaging surface 52, which, in the illustrated embodiment extends across the shaving head 44 and longitudinally of the cartridge retainer 46. The cartridge engaging surface 52 defines a plurality of generally cylindrical portions 54 each adapted to snappingly, releasably, and slidably engage a slot 56, best seen in FIG. 1, extending longitudinally along a surface 58 forming part of a razor cartridge generally designated by the reference number 60. Once the cartridge engaging surface 52 is releasably, snappingly engaged with the slot 56, the razor cartridge 60 can rotate between a non-rotated and a rotated position, as indicated by the arrows labeled “A” in FIGS. 1-3, about the cartridge engaging surface 52. As will be explained in detail herein, the razor cartridge 60 is normally biased toward the non-rotated position.

As shown, the cartridge retainer 46 is partially supported in the interior area 48 for angular movement side-to-side in generally opposite direction from a neutral or central position as indicated by the arrows labeled “B” in FIGS. 1-3, the cartridge retainer being normally biased to the central position.

The razor cartridge 60 is normally biased toward the non-rotated position by a plunger 62, best seen in FIGS. 1, 4, and 5 that projects outwardly from the shaving head 44 and is movable between an extended and a retracted position. When the razor cartridge 60 is mounted to the cartridge retainer 46, the plunger 62 remains in constant biasing communication with the razor cartridge. In addition, an actuator, shown in the illustrated embodiment as a button 66 is pivotally mounted to the shaving head 44 for movement between a neutral position, shown in FIGS. 1 and 4, and a cartridge ejecting position (not shown) wherein the button is fully depressed. The actuator 66 is in biasing communication with the plunger 62, as well as, as will be explained in detail herein, coupled to a pusher.

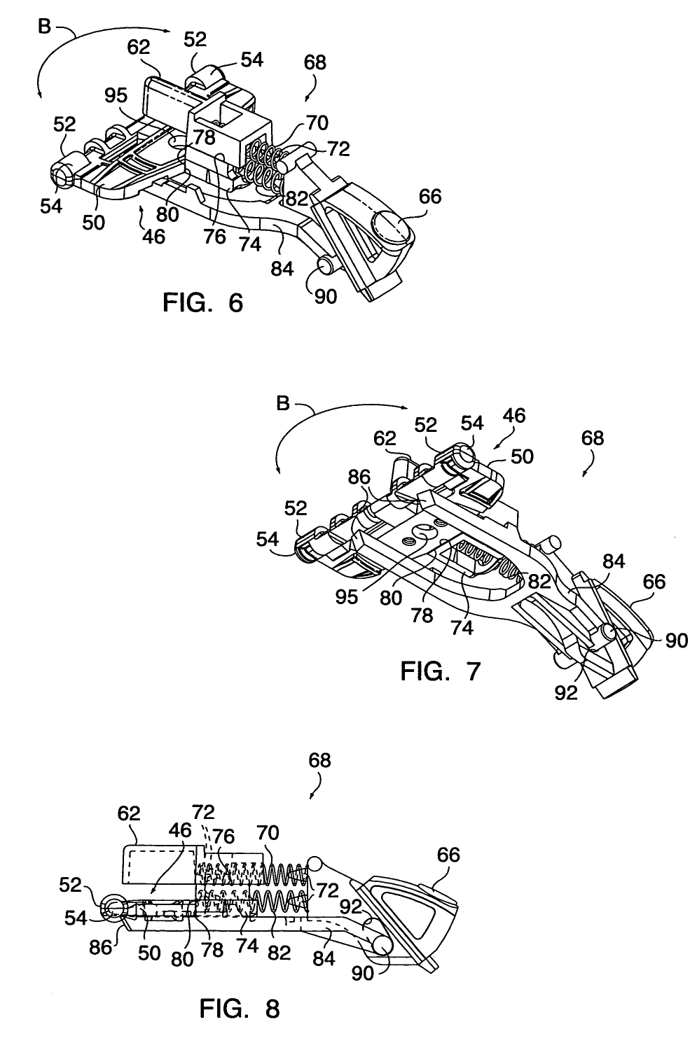

As shown in FIGS. 6-8, the cartridge retainer 46, the actuator 66, and the plunger 62 each form part of a mechanism by which the razor cartridge 60, FIG. 1, is retained, manipulated, and ejected, this mechanism is generally designated by the reference number 68. The mechanism 68 also includes a first spring 70 interposed between and engaging at each end thereof, a rabbet 72, best seen in FIG. 8, projecting outwardly from each of the actuator 66 and the plunger 62. In operation, the spring 70 normally urges the plunger 62 toward the extended position and the actuator 66 toward the neutral position. When the mechanism 68 is incorporated into the shaving implement of the present invention, the plunger 62 is in biasing communication with any razor cartridge 60 mounted to the shaving implement 40.

Still referring to FIGS. 6-8 the mechanism 68 includes a cam block 74, slidably positioned in the interior area 48. The cam block 74 includes a surface 76 that slidably engages a corresponding surface defined by the plunger 62 so that the plunger and the cam block can move relative to one another. The cam block 74 further defines an abutment surface 78 that engages a corresponding surface 80 defined by the cartridge retainer 46. A second spring 82 is interposed between and engages, the cam block 74 and the actuator 66. The second spring 82 biases the abutment surface 78 of the cam block 74 against the corresponding surface 80 of the cartridge retainer 46 thereby urging the cartridge retainer toward the central position as shown in FIGS. 6-8 in response to an externally applied force. When no external force is applied, the cartridge retainer resides in the central position. The second spring 82 also acts in conjunction with the first spring 70 to normally urge the actuator 66 toward the neutral position. While the present embodiment has been shown and described as having an angularly movable cartridge retainer 46, it is not limited in this regard. The cartridge retainer 46 can also be mounted such that it is stationary relative to the shaving head 44.

Still referring to the mechanism 68, the pusher 84 is positioned adjacent the cartridge retainer 46 for movement between an extended position corresponding to the cartridge ejecting position of the actuator 66 and a retracted position corresponding to the neutral position of the actuator. The pusher 84 in the illustrated embodiment is “fork-shaped” having two spaced apart ends 86, each located near the cartridge engaging surface 52 of the cartridge retainer 46. When the mechanism 68 is mounted to the shaving implement 40, and the pusher 84 is moved to the extended position, the ends 86 engage any razor cartridge 60 snappingly coupled to the cartridge retainer 46 and push the razor cartridge off of the cartridge retainer. The manner in which the pusher 84 is moved is described in the following paragraph.

The pusher 84 and the actuator 66 are connected via a linkage defined by an end portion or protuberance 90, forming part of the pusher, being slidably engaged in a slot 92, FIG. 8, defined by the actuator 66. During operation, as the actuator 66 is depressed, the protuberance is forced to move along the slot 92, progressively urging the pusher from the retracted position toward the extended position and thereby into ejecting engagement with the razor cartridge. Upon release, the actuator 66 moves to the neutral position causing the pusher 84 to move to the retracted position.

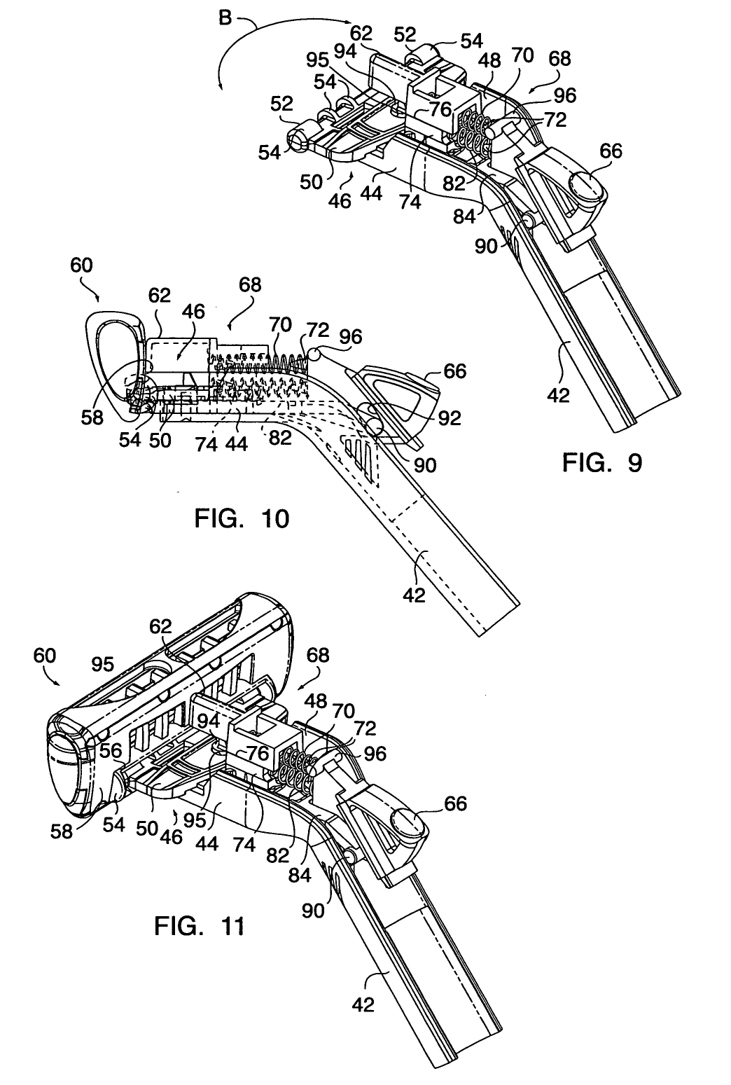

As shown in FIGS. 9-11, the mechanism 68 is mounted to the shaving implement 40 with a portion being partially positioned in the interior area 48 of the shaving head 44. The cartridge retainer 46 is pivotally mounted to the shaving head 44 via a post 94 that extends through an aperture 95. During operation, as the cartridge retainer 46, in response to an externally applied force, moves angularly side-to-side in generally opposite directions as indicated by the arrows labeled “B”, the cartridge retainer rotates about the post 94. The cartridge retainer 46 is urged back to the central position by a biasing force exerted by the abutment surface 78 of the cam block 74 against the cartridge retainer, the biasing force being generated by the spring 82.

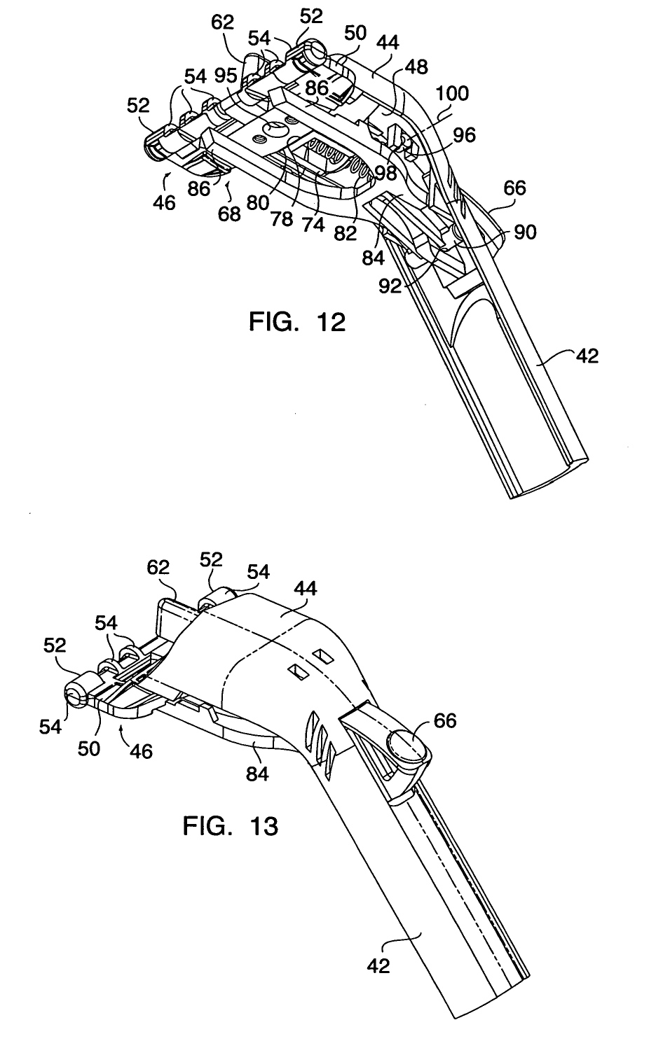

The actuator 66 not only forms part of the mechanism 68 but also includes a mounting portion 96, shown in the illustrated embodiment as being generally cylindrical, by which the actuator is pivotally attached to the shaving implement 40. As shown in FIG. 12 the mounting portion 96 of the actuator 66 rotatably engages a pair of slots 98 (one shown) forming part of the shaving head 44 so that during movement of the actuator form the neutral to the cartridge ejecting position, the actuator rotates about an axis 100 that extends approximately centrally of the mounting portion 96.

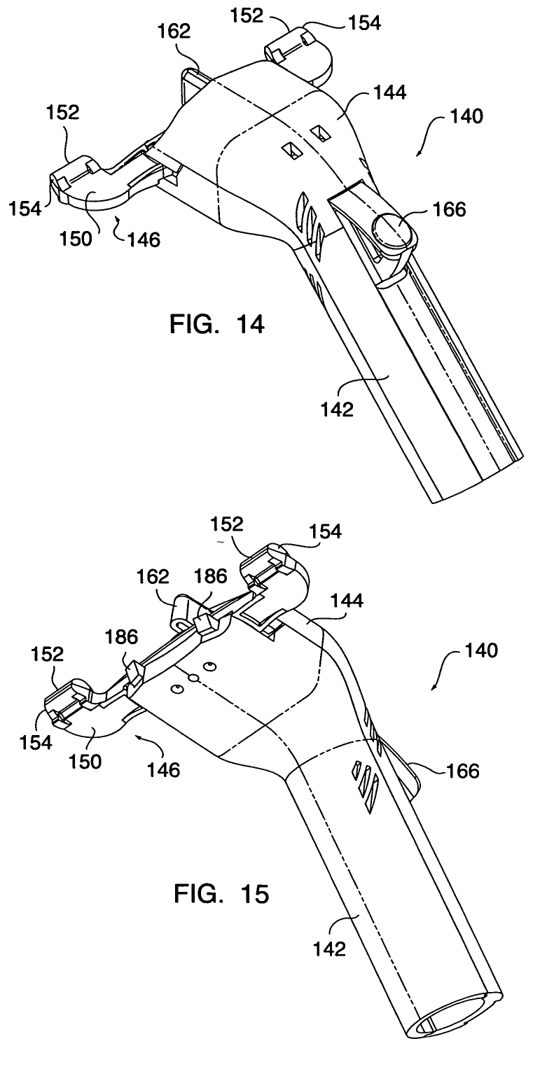

While the above-described embodiment has been shown and illustrated as employing a cartridge retainer 46 have a single cartridge-engaging surface 52 extending longitudinally thereof, the present invention is not limited in this regard. A second embodiment of the cartridge retainer of the present invention, shown in FIGS. 14 and 15, is generally designated by the reference numeral 146. The cartridge retainer 146 is similar in many respects to the cartridge retainer 46 described above, and therefore like reference numerals preceded by the number 1 are used to indicate like elements. The cartridge retainer 146 differs from the cartridge retainer 46 in that instead of a single cartridge-engaging surface 52, a pair of spaced-apart approximately coaxial cartridge engaging surfaces 152 are provided. The cartridge engaging surfaces 152 like the cartridge engaging surface 52 described herein above, releasably, slidably and snappingly engage one or more complimentarily shaped slots defined by a razor cartridge. As best seen in FIG. 15, the plunger 162 and the ends 186 of the pusher extending outwardly from the shaving head 144, operate in exactly the same manner as the above described plunger and pusher ends, 62 and 86 respectively.

While the pusher 84, 184 has been shown as having two spaced apart ends 86, 186, the present invention is not limited in this regard as one or more than two ends may be employed, and assume any one of a number of configurations. In addition, the pusher can also be positioned in a location other than below the cartridge retainer without departing from the broader aspect of the present invention. For example, the pusher could be located above the cartridge retainer.

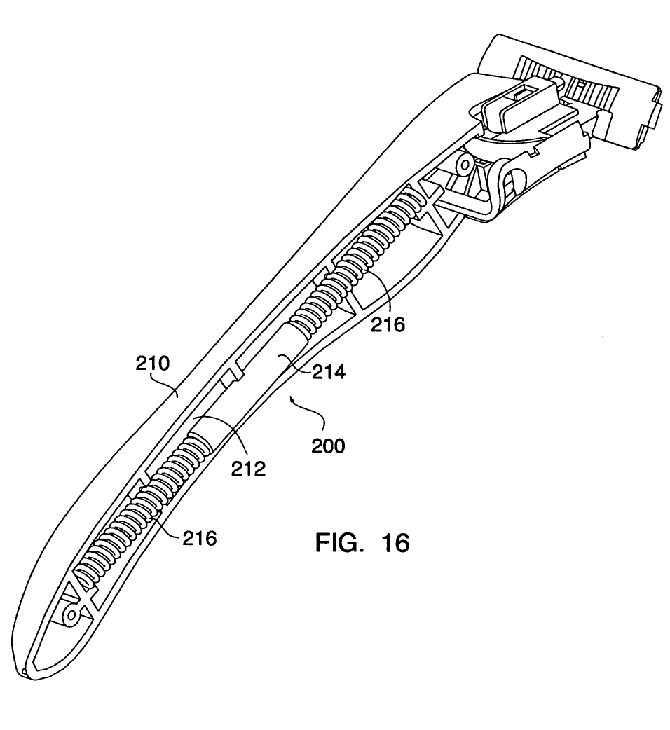

Turning to FIG. 16, the shaving implements of the present invention can each include damping means, generally designated by the reference number 200 for absorbing energy in response to externally exerted impact forces. To support the damping means 200, the shaving implement includes an elongated hand-gripping portion 210 defining an interior cavity 212. At least one weight 214 is slidably positioned within the interior cavity 212. A pair of springs 216 are also positioned within the interior cavity 212 on opposing sides of the weight 214. Each spring 212 abuts the weight 214 at one end and the hand gripping portion 210 at a generally opposite end. When the shaving implement encounters an impact force the weight 214 will oscillate, thereby absorbing at least a portion of the energy due to impact and minimizing damage to the shaving implement. While springs 216 have been illustrated as being in the form of coil springs, the present invention is not limited in this as other configurations such as members formed from elastomeric materials can be substituted without departing from the broader aspects of the present invention.

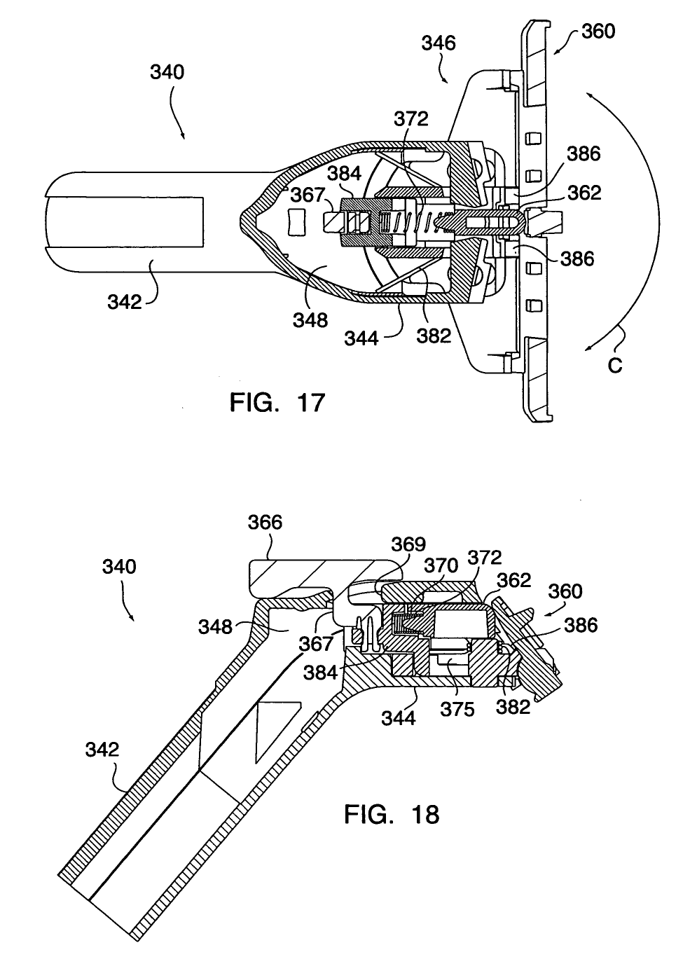

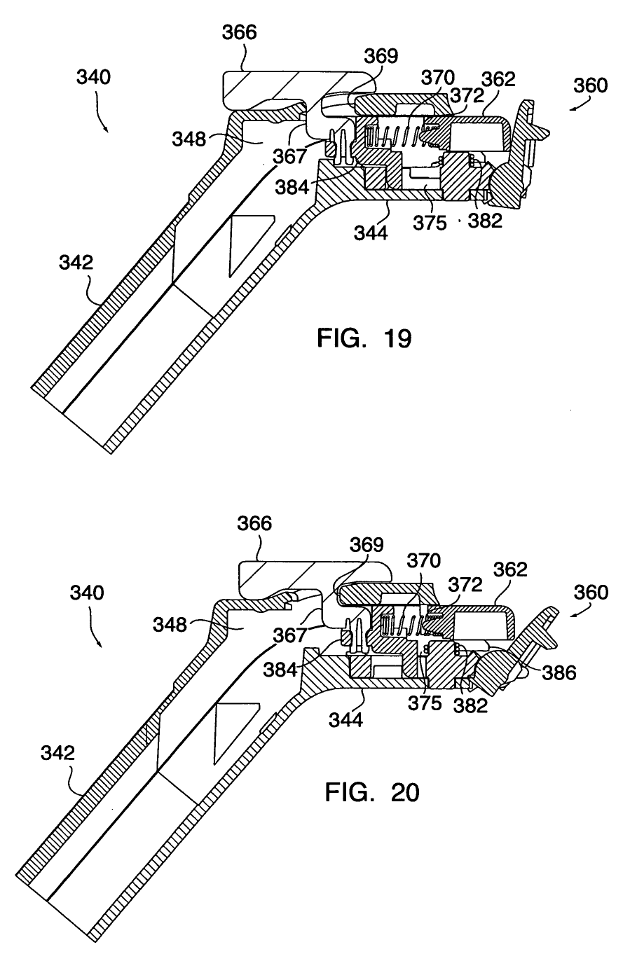

Another embodiment of the shaving implement of the present invention, shown in FIGS. 17-20, is generally designated by the reference numeral 340. The shaving implement 340 is similar in many respects to the shaving implement 40 described above, and therefore like reference numerals preceded by the number 3 are used to indicate like elements. In the illustrated embodiment, the cartridge retainer 346 is mounted to the shaving head 344 and extends partially into an interior area 348 defined thereby. The cartridge retainer 346 is angularly movable in opposite directions from a neutral or central position as indicated by the arrows labeled “C”, FIG. 17. A torsion spring 382 is positioned within the interior area 348 and engages the shaving head 344 and the cartridge retainer 346 to normally bias the cartridge retainer toward the central position. A plunger 362 is slidably mounted to the shaving head 344 for movement between an extended position and a retracted position. A pusher 384 is also slidably positioned in the interior area 348 for movement between a first position corresponding to the actuator 366 being in the neutral position, FIG. 19, and a second position corresponding to the actuator being in the cartridge ejecting position, FIG. 20. The pusher 384 includes a portion 375 having ends 386 that extend approximately centrally of the shaving head 344 and engage the razor cartridge 360 when the pusher is moved to the second position. The pusher 384 operates in much the same manner as the above-described pusher 184. As the pusher 384 moves from the first to the second position, the ends 386 engage the razor cartridge 360 and push it off of the shaving implement. A spring 370 is interposed between and engages the pusher 384 and the plunger 362 so that the plunger maintains engagement with the razor cartridge 360 and a biasing force generated by the spring normally urges the pusher 384 toward the first position. While the cartridge retainer 346 has been described as being angularly movable from side-to-side in generally opposite directions, the present invention is not limited in this regard as the cartridge retainer can also be stationary without departing from the broader aspects of the present invention.

Still referring to FIGS. 17-20, the actuator 366 includes an extension 367 projecting into the interior area 348 through an aperture 369 defined by the shaving head 344. The extension 369 engages the pusher 374 and as the actuator 366 is moved from the neutral position, FIG. 18, to the cartridge ejecting position, FIG. 20, the pusher moves from the first to the second position.

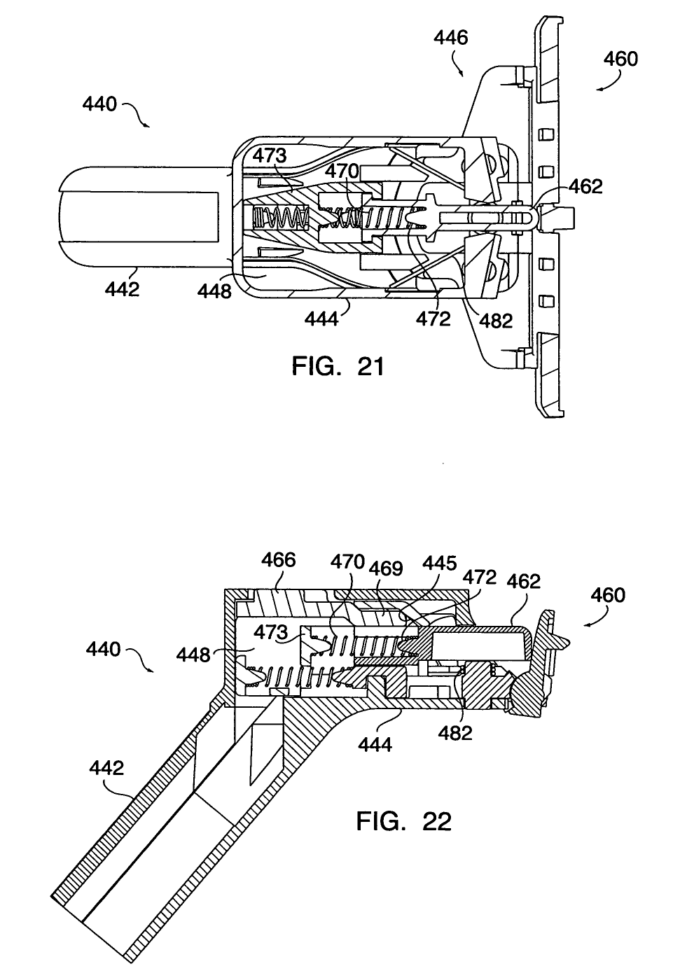

Still another embodiment of the shaving implement of the present invention, shown in FIGS. 21 and 22, is generally designated by the reference numeral 440. The shaving implement 440 is similar in many respects to the shaving implement 340 described above, and therefore like reference numerals preceded by the number 4 are used to indicate like elements. The shaving implement 440 differs from the shaving implement 340 in that there is no pusher. Rather an extension 469 projecting from the actuator 466 engages the plunger 462 as the actuator is moved from the neutral position, to the cartridge ejecting position. To facilitate this motion, the shaving head 444 includes an inclined surface 445 that acts to guide the extension 469 into engagement with the plunger 462. The plunger 462 is urged against the cartridge retainer by a spring 470 interposed between the plunger and a spring support 473. As the actuator 466 is moved toward the cartridge ejecting position, the plunger 462 pushes the cartridge until such time as the cartridge disengages from the shaving implement. As with the previously described embodiment, the cartridge retainer 446 is angularly movable side-to-side from a central position to which it is normally biased. A torsion spring 482 is positioned in the interior area 448 and engages the shaving head 444 and is in biasing communication with the cartridge retainer 446 to urge the cartridge retainer toward the central position in response to an externally applied force. While the cartridge retainer 446 has been described as being movable, the present invention is not limited in this regard as the cartridge retainer can be stationary without departing from the broader aspects of the present invention.

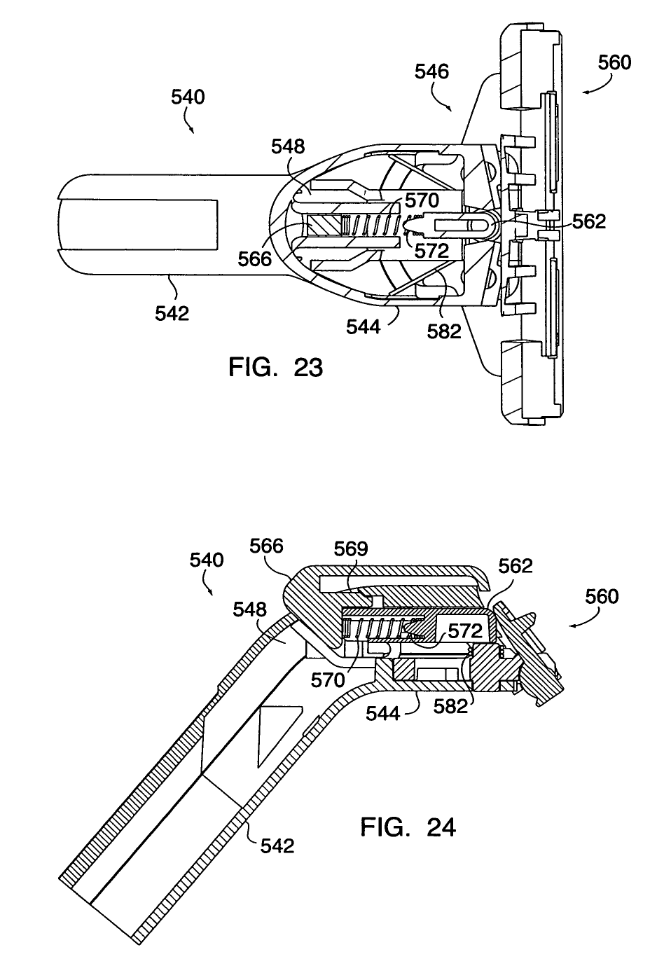

Yet another embodiment of the shaving implement of the present invention, shown in FIGS. 23 and 24, is generally designated by the reference numeral 540. The shaving implement 540 is similar in many respects to the shaving implements 340 and 440 described above, and therefore like reference numerals preceded by the number 5 are used to indicate like elements. The major difference with respect to the embodiment illustrated in FIGS. 23 and 24 and that illustrated in FIGS. 21 and 22 is that the actuator 566 must first be depressed and then slid forward in order for the extension 569 to engage the plunger 562.

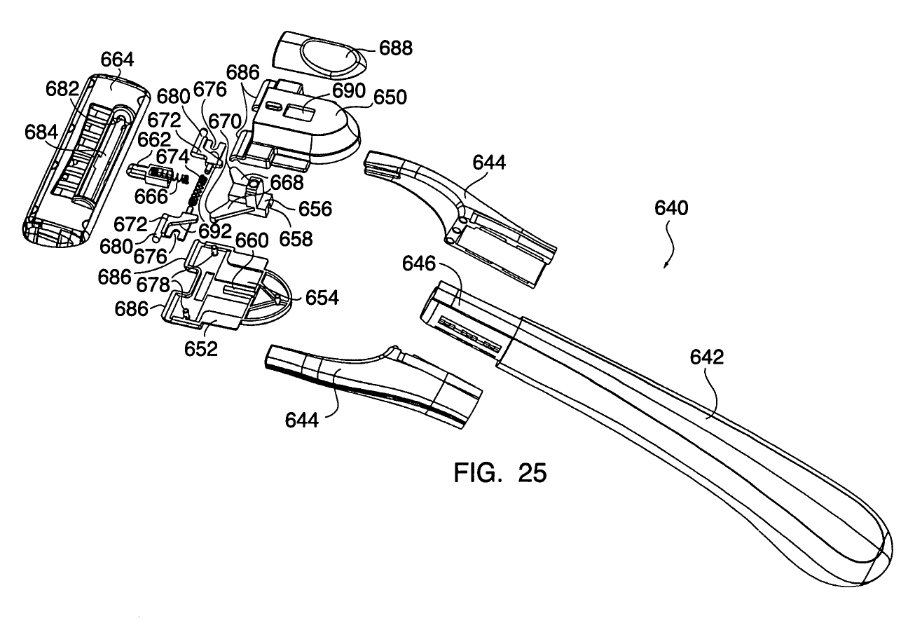

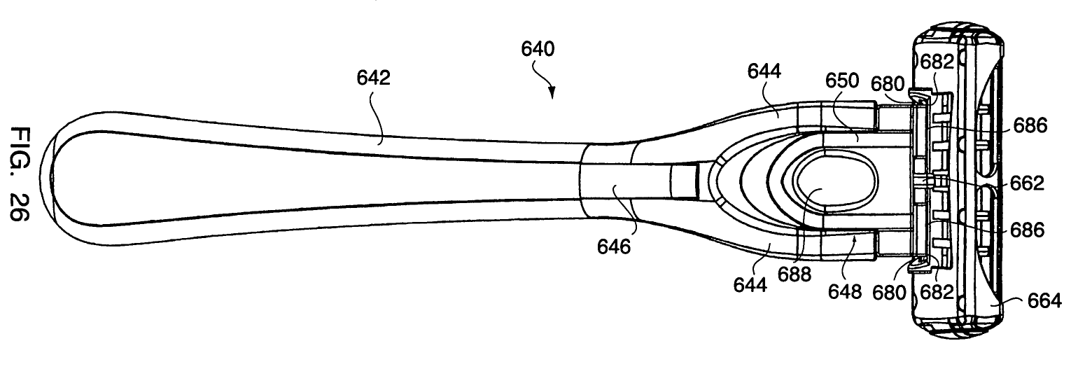

As shown in FIG. 25, another embodiment of the present invention includes a handle portion 642 having a pair of arm members 644 attached at an end 646 thereof. A housing generally designated by the reference number 648 includes first and second housing halves 650 and 652 respectively. When assembled together, the first and second housing halves, 650 and 652 respectively, define an interior area 654. A pusher block 656 is slidably mounted on the second housing half 652 for movement between a first and a second position. The pusher block 656 defines a slot 658 that engages a complimentarily shaped guide 660 to insure rectilinear movement of the pusher block between the first position and the second position. A plunger 662 is slidably mounted within the interior area 654 and engages a razor cartridge 664. A spring 666 is interposed between and engages the plunger 662 and the pusher block 656, thereby urging the pusher block toward the first position and the plunger against the razor cartridge 664.

The pusher block 656 further includes a pair of appendages 668 projecting outwardly therefrom and generally opposite one another. Each appendage 668 defines an end 670, the function of which will be explained in detail below. A pair of retainers 672 are slidably positioned within the interior area proximate the pusher block 656. A second spring 674 is interposed between and engages each retainer 672 to normally urge the retainers toward a cartridge retaining position a notch 676 is defined by each retainer and is adapted to receive a pin 678 extending from the second housing half 652. The pins 678 each restrain the motion of one of the retainers 672. Each of the retainers 672 also includes a pin 680 projecting outwardly therefrom. Each pin 680 extends through the first and second housings, 650 and 652 respectively, and is adapted to slidably engage a mating recess 682 (only one shown) defined by the razor cartridge 664 when the retainers 672 are in the cartridge retaining position. The recesses 682 are located at generally opposite ends of a slot 684 defined by the razor cartridge 664. When assembled, the first and second housing halves, 650 and 652 respectively, collectively define cartridge-engaging surfaces 686. The cartridge engaging surfaces 686 are of a shape complimentary to that defined by the slot 684 in the razor cartridge 664 so as to allow the razor cartridge to slide relative to the cartridge engaging surface between a non-rotated and a fully rotated position.

Still referring to FIG. 25, an actuator 688 is located proximate the first housing half 650 and is movable relative thereto between a cartridge engaging and a cartridge ejecting position. A portion (not shown) of the actuator 688 extends through an aperture 690 in the first housing half 650 and engages the pusher block 656. As the actuator 688 is moved from the neutral to the cartridge ejecting position the ends 670 of the pusher block appendages 668 each progressively engage an inclined surface 692 causing the pin portions 680 to retract from the recesses 682 disengaging the razor cartridge from the shaving implement.

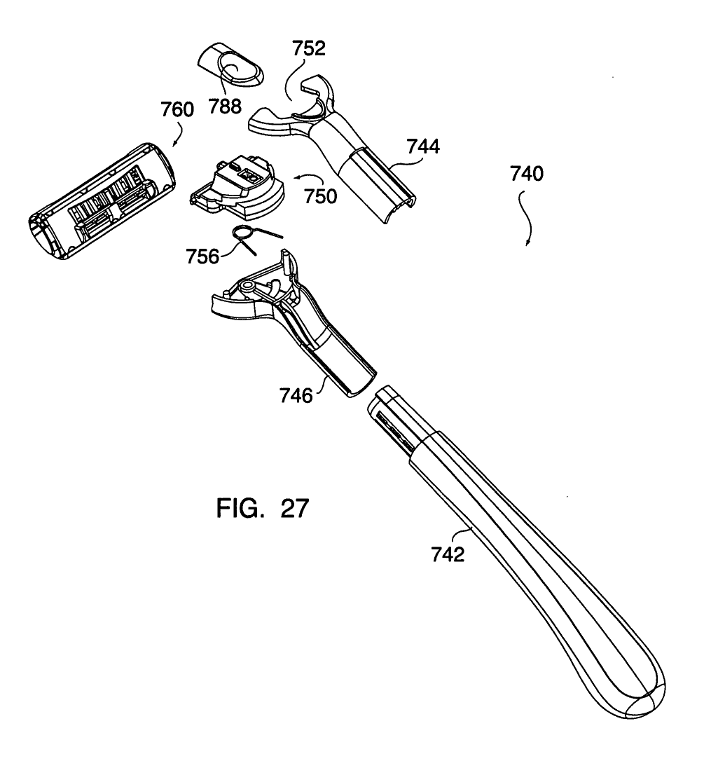

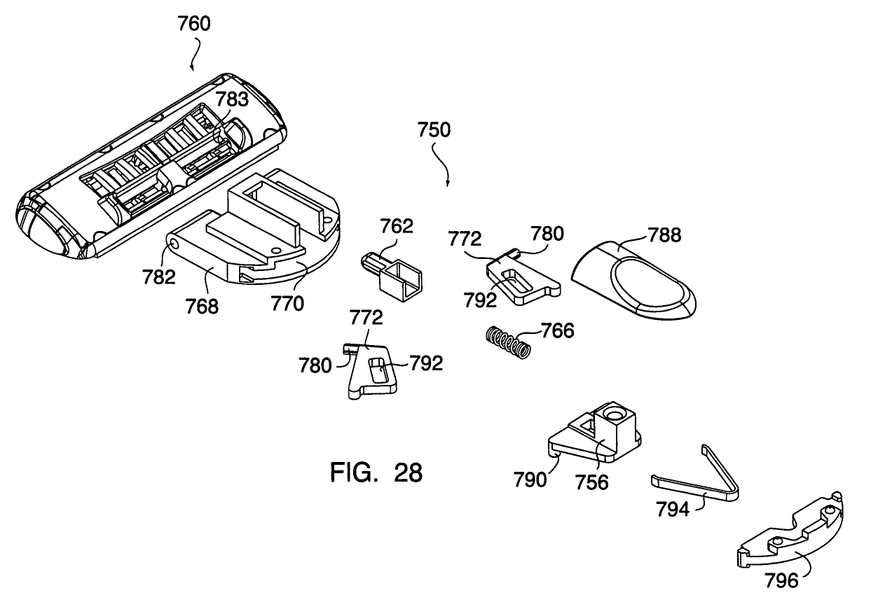

Still another embodiment of the shaving implement of the present invention, shown in FIGS. 27 and 28, is generally designated by the reference number 740. The shaving implement 740 is similar in many respects to the shaving implement 640 described above and therefore like reference numbers preceded by the numeral 7 will be used to designate like elements. The shaving implement 740 includes a handle portion 742 having first and second mating housing sections, 744 and 746 respectively, attached to an end of the handle portion. The first and second housing sections, 744 and 746 respectively, cooperate to define a partially enclosed interior area adapted to receive and rotatably retain a cartridge retaining assembly generally designated by the reference number 750. The first housing section 744 defines an opening 752 at an end thereof, that allows an actuator 788 to be attached to the cartridge retaining assembly 750.

The cartridge retaining assembly 750 is rotatably mounted to the second housing section 746 via a post (not shown) that projects outwardly therefrom and rotatably engages an aperture 754 defined by the second housing section. The cartridge retaining assembly 750 is angularly movable side-to-side in approximately opposite directions from a neutral or central position in response to an externally applied force. The cartridge retaining assembly 750 is normally biased toward the central position via a spring, shown in the illustrated embodiment as a torsion spring 756 interposed between and in biasing communication with the cartridge retaining assembly and the second housing section 746. In this manner, the entire cartridge retaining assembly 750 as well as any razor cartridge 760 mounted thereon can move as a unit angularly side-to-side relative to the handle portion 742 and the first and second housing sections, 744 and 746 respectively.

Referring to FIG. 28, the cartridge retaining assembly 750 includes a main housing 768 defining an opening 770 at one end into which the housing components are positioned. A pair of retainers 772 are positioned within the main housing 768 with each defining a pin 780. Each pin 780 extends through an aperture 782 (only one shown) defined by the main housing 768 and is adapted to engage complimentarily shaped recesses 783 (only one shown) defined by a razor cartridge. A pusher block 756 is slidably positioned within the main housing 768 for movement between a first and second position. The pusher block defines a pair of spaced-apart protuberances 790 that each engage an inclined slot 792 defined by each retainer 772. Accordingly, as the pusher block 756 is moved from the first to the second position, the protuberances 790 progressively engage each inclined slot 792 causing the pins 780 to move rectilinearly from an extended position to a retracted position and to disengage from the recesses 783 in the razor cartridge and thereby release the razor cartridge from the shaving implement 740. To effect movement of the pusher block 756, an actuator 788 is attached thereto and is movable between a neutral position corresponding to the first position of the pusher block, and a cartridge ejecting position corresponding to the second position of the pusher block.

A plunger 762 is also slidably positioned within, and a portion extends outwardly from, the main housing 768. A spring 766 is interposed between and in engagement with the plunger and the pusher block 756. In operation, the plunger normally engages and urges a razor cartridge toward the non-rotated position.

Once all of the above-described components are positioned within the main housing 768, a resilient clip 794 is positioned in the main housing and engages the pusher block 756. A cap 796 is then partially positioned within and attached to the main housing 756. The cap 796 also engages the resilient clip 794 thereby causing all of the above-described components to be retained within the housing.

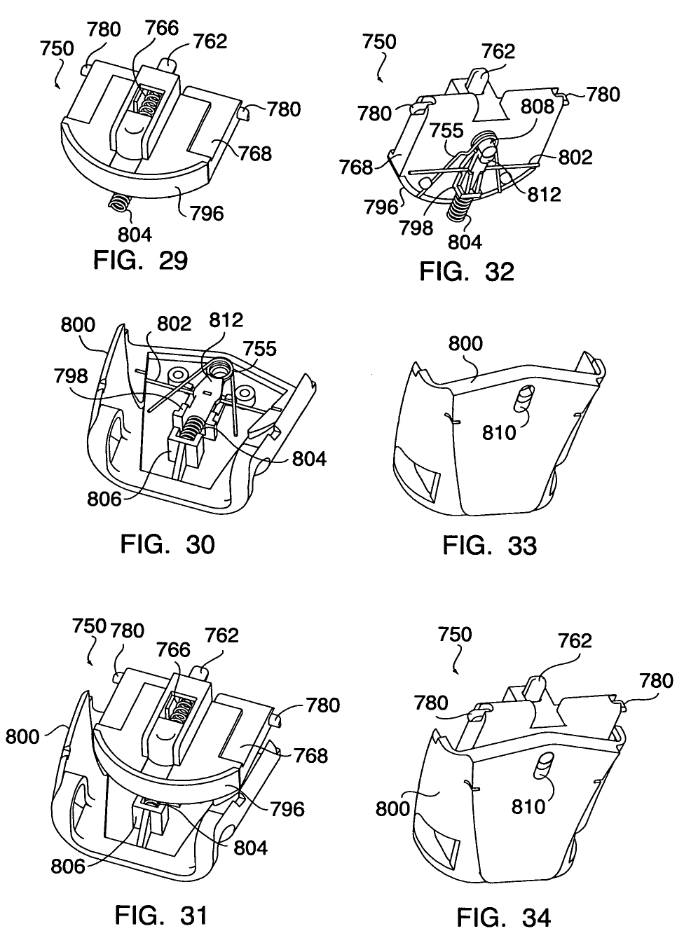

As shown in FIGS. 29-34, the housing 750 can also be configured and mounted to a shaving implement such that energy resulting from an impact to the shaving head is at least partially absorbed. To accomplish this, a damping member 798 is slidably positioned in an impact housing 800 and is attached to a first resilient member 802 which in turn engages the impact housing. A spring 804 is interposed between an end of the damping member 798 and a boss 806 extending from the impact housing 800. The main housing 750 includes a protuberance 808 that projects outwardly from a surface defined by the main housing. The protuberance extends through the torsion spring 755 and is slidably received in a slot 810 defined by the impact housing 800. An end 812 of the damping member 798 engages the torsion spring 755 so that upon impact the main housing 750 slides relative to the impact housing 800 causing the protuberance 808 and thereby the torsion spring 755 to also move relative to the impact housing. The torsion spring 755 then pushes against the damping member 798 causing it also to move relative to the impact housing 800. The resilient member 802 and the spring 804 both act to counteract the movement of the damping member 804 and thereby absorbing at least a portion of any impact loads.

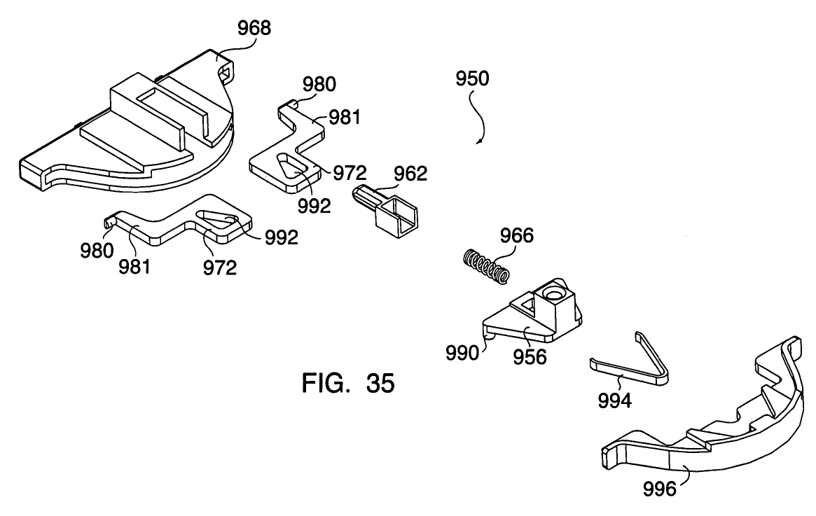

Another embodiment of the above-described cartridge retaining assembly, shown in FIG. 35, is generally designated by the reference numeral 950. The cartridge retaining assembly 950 is similar in many respects to the cartridge retaining assembly 750 and therefore like reference numerals preceded by the number 9 are used to indicate like elements. The difference between the cartridge retaining assembly 750 and that shown in the illustrated embodiment is that the pins 980 forming part of the retainers 972 do not project outwardly from a cartridge engaging surface defined by the main housing 968, but rather are supported by arms 981, also forming part of the retainers, that project outwardly from the main housing.

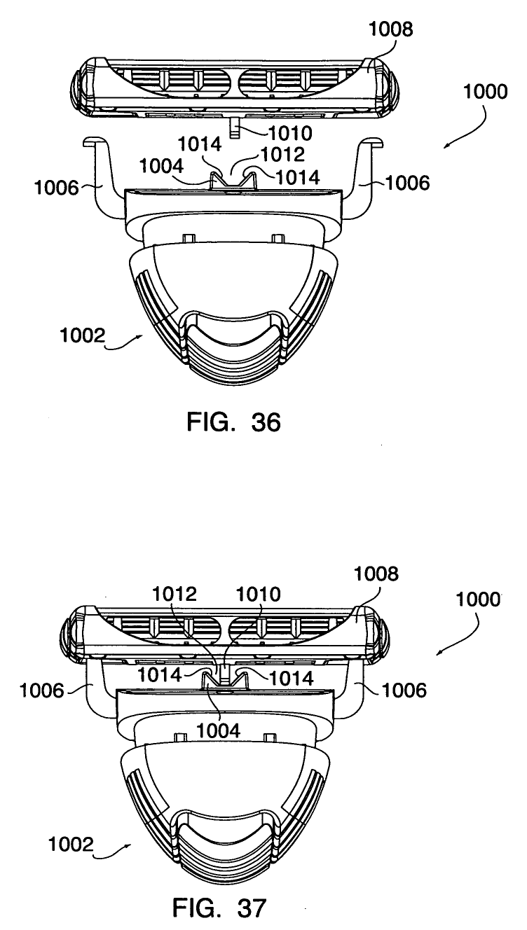

Another embodiment of the above-described cartridge retaining assembly, shown in FIGS. 36 and 37, is generally designated by the reference numeral 1000. In this embodiment a housing generally referred to by the reference number 1002 includes a motion arrestor shown in the illustrated embodiment as a projection 1004 positioned between a pair of retainers 1006, the retainers being adapted to releasably retain a razor cartridge 1008. The razor cartridge 1008 includes an extension 1010 shaped to be positionable within a notch 1012 defined by the projection 1004, when the razor cartridge 1008 is releasably coupled to the retainers 1006. The notch 1012 is defined in-part by inclined side surfaces 1014. The inclined side surfaces 1014 act to aid in guiding the razor cartridge 1008 onto the retainers 1006 and also operate to limit the amount of lateral movement achievable by the razor cartridge. While the motion arrestor 1004 has been illustrated as projecting outwardly from the housing 1002, the present invention is not limited in this regard as the notch 1012 can also extend into the housing without departing from the broader aspects of the present invention.

As will be recognized by those skilled in the pertinent art, numerous changes and modifications may be made to the above described and other embodiments of the present invention without departing from its scope as defined in the appended claims.

What is claimed is:

1. A shaving implement comprising:
a handle having a shaving head defining an interior area;
an actuator coupled to said shaving head for movement between a neutral position, and a cartridge ejecting position;
a cartridge retainer coupled to and having a portion projecting outwardly from said shaving head, said outwardly projecting portion defining at least one cartridge engaging surface adapted to slidably engage a complimentarily shaped slot extending longitudinally of a rear surface defined by a razor cartridge;
retaining means for releasably coupling said cartridge retainer to said razor cartridge so that said razor cartridge is movable between a non-rotated and a rotated position; and
biasing means for urging said razor cartridge toward said non-rotated position in response to an externally applied force.

2. A shaving implement as defined by claim 1 wherein said biasing means includes a plunger coupled to and having a portion extending outwardly from said shaving head, said plunger being movable between an extended position when said razor cartridge is in said non-rotated position and a retracted position when said razor cartridge is in said rotated position.

3. A shaving implement as defined by claim 2 wherein said biasing means further includes a spring interposed between said plunger and said shaving head for normally urging said plunger toward said extended position in response to an externally applied force.

4. A shaving implement as defined by claim 3 wherein said actuator is pivotally coupled to said handle and said spring is interposed between said plunger and said actuator for normally urging said plunger toward said extended position and said actuator toward said neutral position.

5. A shaving implement as defined by claim 1 wherein: at least a portion of said cartridge retainer is supported in said interior area for angular movement of said cartridge retainer in opposite directions from a neutral or central position, said cartridge retainer being normally biased to said central position; and
second biasing means for urging said cartridge retainer toward said central position in response to an externally applied force.

6. A shaving implement as defined by claim 6 wherein said second biasing means includes:
a cam block positioned within said interior area and, slidably coupled to said shaving head, said cam block defining an abutment surface that engages a corresponding surface defined by said cartridge retainer, said cam block being movable between a first position corresponding to said neutral position of said cartridge retainer, and a second position corresponding to a rotated position of said cartridge retainer; and
a spring positioned in said interior area and engaging said cam block for urging said cam block toward said first position in response to an externally applied force.

7. A shaving implement as defined by claim 1 wherein said retaining means is defined at least in part by a portion of said cartridge engaging surface, said portion being releasably and snappingly engagable with said slot defined by said razor cartridge.

8. A shaving implement as defined by claim 7 further comprising:
a pusher slidably coupled to said actuator and located at least in part in said interior area for movement between a retracted position corresponding to said neutral position of said actuator, and an extended position corresponding to said cartridge ejecting position of said actuator, said pusher being normally biased toward said retracted position; and wherein
said pusher, when in said extended position, engages and exerts force against said razor cartridge thereby causing said razor cartridge to disengage from said cartridge retainer.

9. A shaving implement as defined by claim 8 wherein:
said actuator is a button pivotally coupled to said handle and includes a manually manipulable outer portion and an inner portion extending into said interior area;
said inner portion defining a slot adapted to slidably engage a protuberance extending from said pusher so that movement of said actuator from said neutral to said cartridge ejecting position causes said protuberance to progressively move within said slot, thereby producing a corresponding movement of said pusher from said retracted position to said extended position.

10. A shaving implement as defined by claim 8 wherein:
said pusher engages said razor cartridge adjacent a leading edge thereof.

11. A shaving implement comprising:
a handle defining a shaving head having an interior area;
an actuator pivotally coupled to said shaving head for movement between a neutral position, and a cartridge ejecting position;
a cartridge retainer supported in part in said interior area for angular movement side-to-side in generally opposite directions from a neutral or central position, a portion of said cartridge retainer projecting outwardly from said shaving head and defining at least one cartridge engaging surface adapted to slidably and snappingly engage a complimentarily shaped slot extending longitudinally of a rear surface defined by a razor cartridge said razor cartridge being angularly movable relative to said cartridge engaging surface between a rotated and a non-rotated position;
a cam block positioned within said interior area and slidably coupled to said shaving head, said cam block defining an abutment surface that engages a corresponding surface defined by said cartridge retainer, for urging said cartridge retainer toward said central position in response to an externally applied force;
a first spring interposed between and engaging said cam block and said actuator for normally urging said abutment surface into engagement with said cartridge retainer;
a plunger slidably coupled to said shaving head adjacent said cam block for movement between an extended position when said razor cartridge is in said neutral position and a retracted position when said razor cartridge is in said rotated position;
a second spring interposed between and engaging said actuator and said plunger for normally urging said plunger toward said extended position and said actuator toward said neutral position;
a pusher slidably and at least partially positioned in said interior area adjacent at least one of said cam block and said plunger, said pusher being coupled to said actuator for movement between an extended position when said actuator is in said cartridge ejecting position and a retracted position when said actuator is in said neutral position; and wherein
said pusher defines an end that abuts said razor cartridge when said pusher is in said extended position, thereby causing said razor cartridge to disengage from said razor handle.

12. A shaving implement as defined by claim 1 wherein said handle includes damping means for absorbing energy due to impact forces exerted against said shaving implement.

13. A shaving implement as defined by claim 12 wherein:
said handle includes an elongated hand-gripping portion defining an interior cavity;
said damping means includes at least one weight slidably positioned within said cavity; and
at least one resilient member positioned in said interior cavity between said weight and said handle to allow said weight to oscillate in response to said impact forces.

14. A shaving implement as defined by claim 13 wherein:
said resilient member includes a pair of generally opposed springs positioned in said cavity, each interposed between and engaging said weight and said handle.

15. A shaving implement as defined by claim 5 wherein said second biasing means is a torsion spring positioned in said interior area and in biasing communication with said cartridge retainer.

16. A shaving implement as defined by claim 1 wherein:
said actuator is slidably coupled to said shaving head and defines an extension projecting into said interior area;
said biasing means includes a plunger slidably positioned in said
interior area for movement between an extended position and a retracted position, said plunger being normally biased toward said extended position;
a pusher slidably coupled to said shaving head for movement between a first position when said actuator is in said neutral position and a second position when said actuator is in said cartridge ejecting position, said pusher defining an abutment surface adapted to engage a mating surface defined by said extension; and wherein
movement of said pusher toward said second position causes said abutment surface to contact said razor cartridge, with further movement toward said second position causing said cartridge to disengage from said handle.

17. A shaving implement as defined by claim 16 wherein:
at least a portion of said cartridge retainer is supported in said interior area for angular movement in opposite directions from a neutral or central position said cartridge retainer being normally biased toward said central position; and
second biasing means for urging said cartridge retainer toward said central position in response to an externally applied force.

18. A shaving implement as defined by claim 17 wherein said second biasing means is a torsion spring positioned in said interior area and in biasing communication with said cartridge retainer.

19. A shaving implement as defined by claim 16 wherein said shaving head defines a pair of guides between which said pusher is positioned.

20. A shaving implement comprising:
a handle defining a shaving head having an interior area;
an actuator slidably coupled to said shaving head and defining an extension projecting into said interior area;
a cartridge retainer, at least a portion of which is supported in said interior area for angular movement side-to-side from a neutral or central position, a portion of said cartridge retainer projecting outwardly from said shaving head and defining at least one generally cylindrical cartridge engaging surface adapted to slidably engage a complimentarily shaped slot extending longitudinally of a rear surface defined by a razor cartridge;
retaining means for releasably coupling said cartridge retainer to said razor cartridge;
said razor cartridge being angularly movable between a non-rotated and a rotated position;
a plunger slidably positioned in and having a portion extending outwardly from said shaving head for engaging said razor cartridge said plunger being movable between an extended position and a retracted position;
an pusher slidably coupled to said shaving head for movement between a first position when said actuator is in said neutral position and a second position when said actuator is in said cartridge ejecting position, said pusher defining an abutment surface adapted to engage a mating abutment surface defined by said extension;
first biasing means interposed between said pusher and said plunger for urging said plunger toward said extended position and thereby said razor cartridge toward said non-rotated position;
second biasing means for urging said cartridge retainer toward said central position in response to an externally applied force; and whereby
movement of said actuator to said cartridge ejecting position causes said abutment surface defined by said extension to engage said abutment surface defined by said pusher, thereby causing said pusher to bear against and disengage said razor cartridge from said cartridge retainer.

21. A shaving implement as defined by claim 1 wherein:
said actuator is a button having a manually manipulable outer portion and an interior portion located within said interior area and defining a protuberance adapted to slidably engage a slot defined by said shaving head;
said cartridge retainer is supported in said interior area for angular movement side-to-side in generally opposite directions from a neutral or central position;
said biasing means includes a plunger slidably mounted in said interior area and movable between an extended position and a retracted position, said plunger being normally biased towards said extended position; said shaving implement further comprising
an ejector slidably coupled to said having head for movement between a neutral position corresponding to said neutral position of said actuator, and an ejecting position wherein said ejector pushes said razor cartridge off of said handle, said ejector defining a first abutment surface adapted to engage a mating second abutment surface defined by said actuator; and wherein
said slot defines, an inclined portion to allow retrograde movement of said actuator from said neutral position to a position wherein said first and second abutment surfaces are engaged, and a rectilinear portion to allow movement of said actuator and said ejector to said cartridge ejecting position.

22. A shaving implement as defined by claim 21 further comprising second biasing means for urging said cartridge retainer toward said central position in response to an externally applied force.

23. A shaving implement as defined by claim 22 wherein said second biasing means includes a torsion spring located within said interior area and in biasing communication with said cartridge retainer.

24. A shaving implement as defined by claim 21 wherein said biasing means further includes a spring interposed between said plunger and said actuator.

25. A shaving implement as defined by claim 1 wherein:
said actuator includes an interior portion located within said interior area;
said biasing means includes a plunger slidably positioned in and having a portion extending outwardly from said interior area said plunger being movable between an extended position and a retracted position, with said plunger being normally biased towards said extended position; and
said actuator being movable from said neutral position toward and at least partially into said interior area and then rectilinearly to engage said plunger, so that further manipulation of said actuator causes said plunger to move past said extended position thereby causing said razor cartridge to disengage from said handle.

26. A shaving implement as defined by claim 25 wherein said cartridge retainer is at least partially positioned in said interior area for angular movement side-to-side in generally opposite directions from a neutral or central position.

27. A shaving implement as defined by claim 26 further comprising second biasing means for urging said cartridge retainer toward said neutral position in response to an externally applied force.

28. A shaving implement as defined by claim 27 wherein said second biasing means is a torsion spring positioned in said interior area and in biasing communication with said cartridge retainer.

29. A shaving implement as defined by claim 1 wherein:
said handle includes a hand-gripping portion and said shaving head defines a housing coupled to said hand gripping portion;
said biasing means includes a plunger slidably positioned in said housing for movement between an extended position and a retracted position, said plunger being normally biased towards said extended position and in engagement with a razor cartridge mounted to said handle; and
said retaining means includes a shaped pin projecting outwardly from said cartridge engaging surface and adapted to be received in a complimentarily shaped recess defined by said razor cartridge, said pin being coupled to said actuator so that movement thereof from said neutral to said cartridge ejecting position causes said pin to move from an extended to a retracted position, said pin being normally biased toward said extended position.

30. A shaving implement as defined by claim 29 wherein:
said at least one cartridge engaging surface includes a pair of approximately coaxial cartridge engaging surfaces each defining an end;
said retaining means includes a pair of generally opposed shaped pins, one extending from said end of each of said cartridge engaging surfaces, each shaped pin being adapted to be received in a complimentarily shaped recess defined by said razor cartridge; and wherein
each of said shaped pins is coupled to said actuator so that movement thereof from said neutral to said cartridge ejecting position causes said pin to move from an extended to a retracted position, said pins being normally biased toward said extended position.

31. A shaving implement as defined by claim 1 wherein:
said handle includes a hand-gripping portion and said shaving head defines a housing coupled to said hand gripping portion;
said housing includes a first housing section and a second housing section coupled to said first housing section;
said cartridge retainer forming part of said second housing section;
said biasing means includes a plunger coupled to said second housing section for movement relative thereto between an extended position and a retracted position, said plunger being normally biased toward said extended position;
said actuator being coupled to said second housing section for movement therewith.

32. A shaving implement as defined by claim 31 wherein said housing is angularly movable side-to-side in generally opposite direction.

33. A shaving implement as defined by claim 31 further comprising absorption means for dissipating energy generated from impact forces directed against said shaving head.

34. A shaving implement as defined by claim 33 wherein said absorption means includes:
said second housing being slidably coupled to said shaving implement for movement between an operating position and a damping position said second housing section being normally biased toward said operating position.

35. A shaving implement comprising:
a handle having a hand gripping portion and a housing coupled to an end of said hand gripping portion;
said housing being defined by first and second housing sections coupled to one another;
said housing defining a pair of generally cylindrical cartridge engaging surfaces spaced apart from, and approximately coaxial with one another, each cartridge engaging surface being adapted to slidably engage a complimentarily shaped slot extending longitudinally of a rear surface defined by a razor cartridge;
said razor cartridge being movable between a non-rotated and a rotated position;
a plunger slidably coupled to said second housing section and in engagement with said razor cartridge, said plunger being movable between an extended position and a retracted position;
first biasing means for urging said plunger toward said extended position, and thereby said razor cartridge toward said non-rotated position in response to an externally applied force;
a pair of pins, one extending from an end of each cartridge engaging surface, each pin being movable between a retracted position and an extended position, said pins being adapted to slidably engage complimentarily shaped recesses defined by said razor cartridge;
an actuator coupled to said second housing section and to each of said pins, said actuator being movable between a neutral position corresponding to said extended position of said pins and a cartridge ejecting position corresponding to said retracted position of said pins.

36. A shaving implement as defined by claim 35 wherein said housing is coupled to said handle for angular movement side-to-side in approximately opposite directions from a central position.

37. A shaving implement as defined by claim 1 wherein:
said shaving head includes a main housing coupled thereto, said cartridge retainer being incorporated into said main housing so that said cartridge engaging surface is defined by an outer portion of said main housing;
said retaining means include a pair of generally opposed shaped pins projecting outwardly from said cartridge engaging surface, each pin being, movable between an extended and a retracted position and receivable within a complimentarily shaped recess defined by said razor cartridge; and wherein said actuator is coupled to said main housing and said pins so that
movement of said actuator from said neutral to said cartridge ejecting position causes said pins to move from said extended to said retracted position.

38. A shaving implement as defined by claim 37 wherein said main housing is angularly movable side-to-side in approximately opposite directions from a central position.

39. A shaving implement as defined by claim 38 wherein said main housing is normally biased toward said central position.

40. A shaving implement as defined by claim 38 wherein:
said main housing defines an opening on a rear surface thereof, said opening being in communication with said interior area;
a pair of retainers each defining one of said shaped pins is positioned in said interior area via said opening, each of said retainers defining a slot;
a pusher block is slidably positioned in said housing via said opening and defines a pair of protuberances depending therefrom, each slidably received in one of said slots defined by said retainers;
said pusher block being movable between a first and second position so that movement from said first to said second position causes said protuberances to progressively engage said slots thereby causing said pins to move from said extended to said retracted position;
said biasing means includes a plunger slidably positioned in said main housing and having an end engageable with a razor cartridge coupled to said shaving implement;
a resilient clip positioned in said interior area and having a portion that abuts said pusher block for exerting pressure thereagainst to maintain the position of components located in said main housing;
a cap positioned in said opening, sand bearing against said resilient clip; and wherein
said biasing means further includes a spring positioned between said plunger and said cap for urging said plunger toward said extended position.

41. A shaving implement as defined by claim 37 wherein said main housing is unitary and form from a single piece of material.

42. A shaving implement as defined by claim 37 further comprising;
an impact housing coupled to said handle and adapted to slidably receive said main housing;
a damper slidably coupled to said impact housing and engageable with said main housing so that upon impact said main housing will slide relative to said impact housing and engage said damper; and
biasing means interposed between said damper and said impact housing for absorbing at least a portion of any forces exerted thereagainst by said damper resulting from an impact.

43. A shaving implement as defined by claim 42 wherein said biasing means includes a spring.

44. A shaving implement as defined by claim 43 wherein:
said spring is a coil spring and said biasing means further includes;
a resilient member coupled to said damper and engaging said impact housing.

45. A shaving implement as defined by claim 42 wherein said main housing defines a projection extending therefrom and slidably receivable in a slot defined by said impact housing; and wherein
said damper is engageable with said projection.

46. A shaving implement as defined by claim 42 wherein said main housing defines a projection extending therefrom and slidably receivable in a slot defined by said impact housing;
said projection being in biasing communication with a torsion spring positioned in said impact housig;
said main housing being angularly movable side-to-side relative t said handle from a central position and normally biased by said torsion spring toward said central position; and wherein
said damper is engageable with said torsion spring.

47. A shaving implement as defined by claim 1 wherein: said shaving head includes a main housing coupled thereto and defining said interior area, said main housing further defining an opening in communication with said interior area;
said cartridge retainer includes a pair of retainers each at least partially positioned in said interior area via said opening;
said retaining means including an arm defined by each retainer, each arm having a pin portion at an end thereof, each pin portion being receivable in a complimentarily shaped recess defined by a razor cartridge;
a pusher block positioned in said main housing via said opening, said pusher being coupled to each of said retainers so that movement of said pusher from a first to a second position causes each retainer and thereby said pins to move from an extended position to a retracted position;
a resilient clip positioned in said interior area and abutting said pusher block so that said clip exerts pressure against said pusher block thereby retaining said pusher block in registration with one another; and
a cap coupled to said housing and engaging said resilient clip.

48. A shaving implement as defined by claim 47 wherein said biasing means includes:
a plunger slidably positioned in said main housing and defining an end engageable with a razor cartridge for normally biasing said razor cartridge toward a non-rotated position.

49. A shaving implement as defined by claim 1 wherein:
said shaving head defines a housing that includes a notch defined in-part by a pair of generally opposed side surfaces;
said razor cartridge includes an extension projecting therefrom; and
said extension is at least partially positioned in said notch when said razor cartridge is coupled to said cartridge retainer so that said side surfaces limit lateral movement of said razor cartridge.

50. A shaving implement as defined by claim 49 wherein said shaving head defines a housing having a projection extending outwardly therefrom, said notch being positioned in said projection.

51. A shaving implement comprising:
a handle;
a shaving head coupled to said handle and including a housing, defining an interior area;
a pair of retainers, a portion of each being located within said interior area and coupled to said housing for movement between a cartridge engaging and a cartridge ejecting position, and a portion of each retainer projecting outwardly from said housing;
a notch defined by said housing for receiving at least a portion of an extension projecting outwardly from a razor cartridge when said razor cartridge is releasably coupled to said retainers;
said notch is defined in part a pair of generally opposed side walls, said side walls; and wherein
excessive lateral movement of said razor cartridge relative to said shaving head will be prevented by said extension contacting said side walls.

52. A shaving implement as defined by claim 51 wherein said housing includes a projection extending outwardly therefrom, said notch being positioned in said projection.
